(19) United States
(12) Patent Application Publication
(10) Pub. No.: US 2025/0229172 A1
(43) Pub. Date: Jul. 17, 2025

(54) Multi-Functional Gaming Input Device with Combined Mouse and Joystick

(71) Applicant: Slavomir Stasko, Fairport, NY (US)

(72) Inventor: Slavomir Stasko, Fairport, NY (US)

(21) Appl. No.: 18/410,947

(22) Filed: Jan. 11, 2024

(51) Int. Cl. A63F 13/24

(52) U.S. Cl. CPC A63F 13/24

(57) ABSTRACT

The described device introduces an interactive input device designed to enhance the video gaming experience by integrating a mouse-based control system with traditional gaming interfaces. The device features an ergonomically designed base to support the user's hand, ensuring comfort during prolonged gaming sessions. Affixed to this base is a mouse component, which houses a circuit board responsible for generating precise control signals. Connected to the mouse is a tube that translates the lateral mouse movements into corresponding motions. This movement is then translated into electronic joystick signals by an analog potentiometer, which is mechanically linked to the tube. A strategically placed rubber sheet between the mouse and the base ensures the mouse's smooth and steady movement. This hybrid device optimizes control fidelity in video gaming, offering a seamless and responsive interface that marries the precision of a mouse with the intuitive control of a joystick.

### BACKGROUND

The convergence of different control mechanisms in gaming devices has been a constant pursuit in the field of video game technology. Traditional game controllers offer user-friendly interfaces but often lack the precise control provided by a computer mouse. While a mouse offers high precision, it's not always well-suited for the dynamic input required in modern gaming.

Existing methods to integrate mouse-like functionalities into gaming controllers have been explored. For instance, third-party software solutions like Xpadder or JoyToKey enable game controllers to function as mice by remapping controller buttons to simulate mouse movements and clicks. This approach, as detailed by “The Tech Edvocate”, allows users to use their game controllers for tasks typically requiring a mouse, such as browsing the web or watching videos on a Windows PC.

Furthermore, Analog Devices Inc, discusses the technical aspects of transforming game controller signals into a USB mouse data format. This involves processing analog stick movements and button presses into formats interpretable as mouse inputs by a computer, including x-axis and y-axis displacement and button clicks.

These existing methods, while innovative, often require additional software, may introduce latency, or lack the ergonomic design suited for prolonged gaming sessions. Consequently, there remains a need for an integrated device that seamlessly combines the precision of a mouse with the intuitive control of a joystick, without the drawbacks of current solutions.

### SUMMARY

In view of the circumstances outlined above, aspects of the present described device discloses systems and methods for the implementation of a multi-functional gaming input device with combined mouse and joystick.

According to one aspect of the described device, there is provided an interactive input device for video game control, comprising: a base to support the user's hand, promoting comfortable extended gameplay; a mouse component affixed to the base, including a mouse circuit board for generating responsive control signals; a tube connected to the mouse, responsive to its movement, and an analog potentiometer mechanically linked to the tube, designed to convert the motion into electronic joystick signals; a rubber sheet positioned strategically between the mouse and the base to minimize the degree of play between the aforementioned components.

According to a further aspect of the described device, the mouse component includes at least two buttons and a scroll wheel to augment game control, the mouse circuit board is configured to process button clicks and scroll actions, thereby generating additional control signals for a multifaceted gaming experience. The analog potentiometer includes a 2-axis joystick capable of registering multi-directional movement, offering nuanced control in a video game environment. Additionally, an adhesive material secures the tube to the mouse component, ensuring motion transfer. The device also includes a communication interface to transmit the electronic joystick signals to a video game console or computer, ensuring seamless integration with existing gaming ecosystems.

### BRIEF DESCRIPTION OF THE DRAWINGS

FIG. 1 is a diagram illustrating an interactive input device.

FIG. 2 is a diagram illustrating the base component comprising, scroll pad and mouse components of the interactive input device.

FIG. 3 is a diagram further illustrating the interactive scroll pad and mouse components of the interactive input device in the sagittal plane with the mouse component in the anterior position.

FIG. 4 is a diagram further illustrating the interactive the scroll pad and mouse components of the interactive input device in the sagittal plane with the mouse component in the posterior position.

FIG. 5 is a diagram further illustrating the interactive the scroll pad and mouse components of the interactive input device in the transverse plane with the mouse component in the left lateral position.

FIG. 6 is a diagram further illustrating the interactive the scroll pad and mouse components of the interactive input device in the transverse plane with the mouse component in the right lateral position.

### DETAILED DESCRIPTION

Possible embodiments illustrative of the present described device are described with reference to the attached drawings. Note that constituents denoted by the same symbols have the same or similar configurations in respective figures.

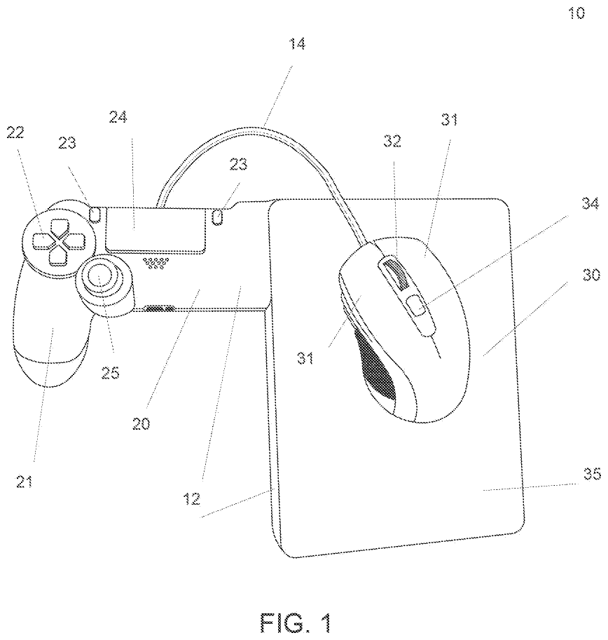

FIG. 1 is a diagram that describes an interactive input device 10, according to the present described device, with housing 12. The interactive input device 10 comprises: a controller with a handle portion 21 to wirelessly connect with the associated computing device configured for a video game; a scroll pad 35 attached to the controller with a handle portion 21, to support a user's hand; a mouse component 30 attached to the scroll pad 35; an I/O cable 14 connecting the joystick 20 to the mouse component 30 with scroll wheel 32, switch 34, and clicker 31. The mouse component 30 may include a mouse circuit board 46 for generating control signals.

In some embodiments the controller with a handle portion 21 may include further interactive elements for user input comprising: programmable switches 23; directional buttons 22; a touch pad 24; a 2-axis joystick analog potentiometer 25.

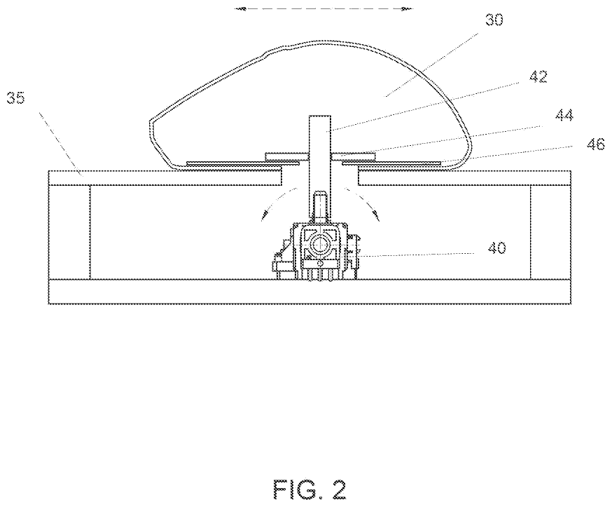

FIG. 2 is a diagram that depicts the architecture of the base component which facilitates the mouse-controller movement translation mechanism. The mouse-controller movement mechanism comprises: a tube 42 connected to the mouse component 30 and configured to move in response to the mouse component's 30 motion, a 2-axis joystick 40 mechanically linked to the tube 42 and configured to convert the motion of the tube 42 into electronic joystick signals; a rubber sheet 44 positioned between the mouse component 30 and the scroll pad 35 to minimize the degree of play between the two, facilitating smooth movement of the mouse component; and mouse circuit board 46. The scroll pad 35 and handle portion may include a housing component to protect the controller internals and optimize the ergonomics of the interactive input device for user comfort.

Some embodiments may include: a 2-axis joystick 40 capable of detecting multi-directional movement; glue or similar adhesive material being used to secure the tube 42 to the mouse component 30 to ensure consistent transfer of motion;

In other possible variations of the present described device, the interactive input device may include a communication interface for transmitting the 2-axis joystick's 40 signals to a video game console or computer; the 2-axis joystick 40 may be calibrated to correspond to the mouse component's 30 motion to proportional joystick input values for precise control in the video game; the mouse component 30 may be detachable from the scroll pad 35 for maintenance or replacement; the mouse component 30 may include at least two buttons and a scroll wheel 32; the mouse circuit board 46 may be configured to process clicks from the aforementioned buttons and scrolling action from the scroll wheel 32 to generate additional control signals.

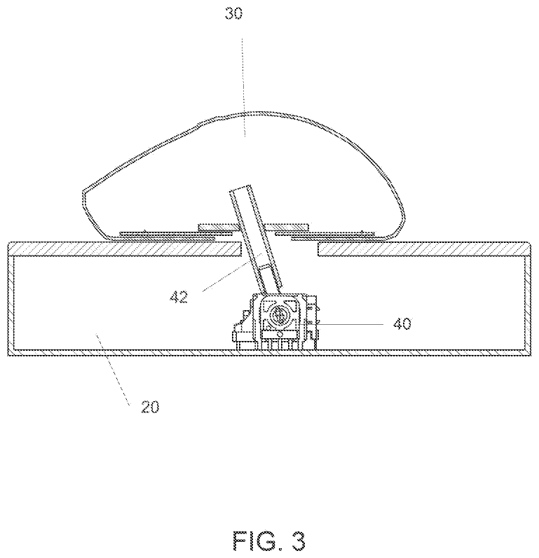

FIG. 3 depicts a sagittal cross section of the architecture of the mouse-controller movement translation mechanism depicted in FIG. 2. In this embodiment the mouse component 30 within housing 20 is displaced in the anterior position pushing the tube 42 causing actuation and forward signal generation in the 2-axis joystick 40.

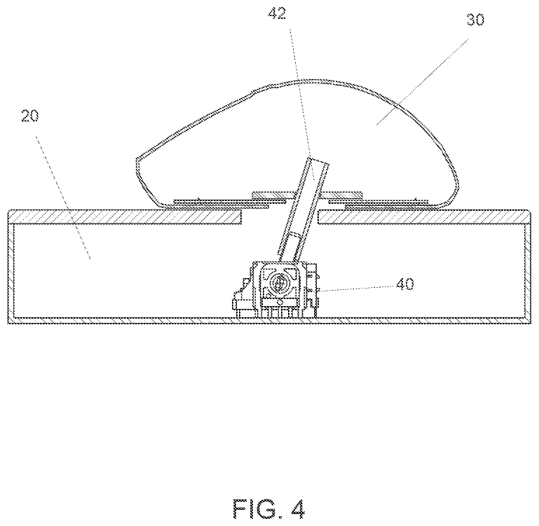

FIG. 4 depicts a sagittal cross section of the architecture of the mouse-controller movement translation mechanism depicted in FIG. 2. In this embodiment the mouse component 30 within housing 20 is displaced in the posterior position pushing the tube 42 causing actuation and backward signal generation in the 2-axis joystick 40.

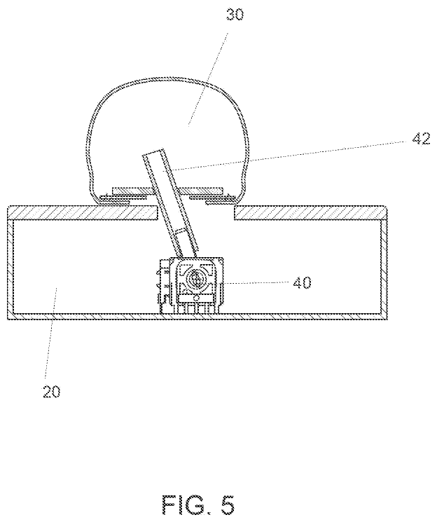

FIG. 5 depicts a transverse cross section of the architecture of the mouse-controller movement translation mechanism depicted in FIG. 2. In this embodiment the mouse component 30 within housing 20 is displaced in the left lateral position pushing the tube 42 causing actuation and leftward moving signal generation in the 2-axis joystick 40.

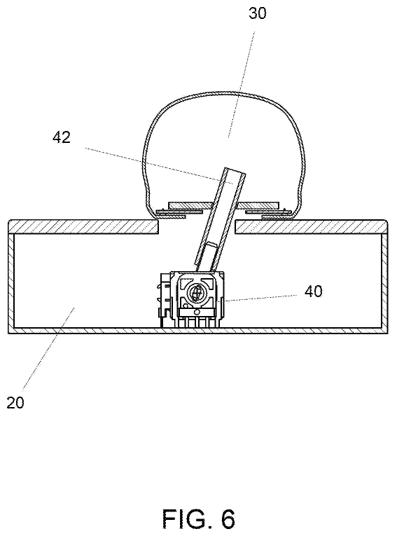

FIG. 6 depicts a transverse cross section of the architecture of the mouse-controller movement translation mechanism depicted in FIG. 2. In this embodiment the mouse component 30 within housing 20 is displaced in the right lateral position pushing the tube 42 causing actuation and rightward moving signal generation in the 2-axis joystick 40.

The embodiments described above are given for the purpose of facilitating the understanding of the present described device and are not intended to limit the interpretation of the present described device. The respective elements and their arrangements, materials, conditions, shapes, sizes, or the like of the embodiment are not limited to the illustrated examples but may be appropriately changed. Further, the constituents described in the embodiment may be partially replaced or combined together.

What is claimed is:

1. An interactive input device for controlling a video game, comprising: a base configured to support a user's hand; a mouse component attached to the base, including a mouse circuit board for generating control signals; a tube connected to the mouse component and configured to move in response to mouse motion; an analog potentiometer mechanically linked to the tube and configured to convert the motion of the tube into electronic joystick signals; a rubber sheet positioned between the mouse component and the base to minimize the degree of play between the two components facilitating smooth movement of the mouse component.

2. The device of claim 1, wherein the mouse component comprises at least two buttons and a scroll wheel; and the mouse circuit board is configured to process clicks from the buttons and scrolling action from the scroll wheel to generate additional control signals.

3. The device of claim 1, wherein the analog potentiometer comprises a 2-axis joystick capable of detecting multi-directional movement.

4. The device of claim 1, wherein glue or similar adhesive material is utilized securing the tube to the mouse component to ensure consistent transfer of motion.

5. The device of claim 1, wherein the base includes a flat surface to rest on a user's lap or a table.

6. The device of claim 1, further comprising a communication interface for transmitting the electronic joystick signals to a video game console or computer.

7. The device of claim 1, wherein the mouse component is detachable from the base for maintenance or replacement.

8. A method for converting mouse motion into joystick control signals for video game interaction, comprising: detecting movement of a mouse component over a base; transferring the detected movement to a tube connected to the mouse component; converting the movement of the tube into electronic signals with an analog potentiometer; transmitting the electronic signals to a video game console or computer for controlling game actions.

9. The method of claim 8, wherein the movement of the mouse component is guided by a rubber sheet to ensure eliminate play between the mouse component and the base component.

10. The method of claims 1 and 9, wherein the springs or other shock absorbing mechanisms may be substituted to eliminate play between the mouse and base components.

11. The device of claim 8, wherein the analog potentiometer is calibrated to correspond the mouse motion to proportional joystick input values for precise control in the video game.
